(19) United States
(12) Patent Application Publication
(10) Pub. No.: US 2026/0001442 A1
(43) Pub. Date: Jan. 1, 2026

(54) Battery Control Apparatus and Method Thereof

(71) Applicants: HYUNDAI MOTOR COMPANY, Seoul (KR); KIA CORPORATION, Seoul (KR)

(72) Inventors: Yo Han Baek, Hwaseong-si (KR); Bo Hyun Lee, Hwaseong-si (KR)

(73) Assignees: HYUNDAI MOTOR COMPANY, Seoul (KR); KIA CORPORATION, Seoul (KR)

(21) Appl. No.: 18/931,703

(22) Filed: Oct. 30, 2024

(30) Foreign Application Priority Data
Jul. 1, 2024 (KR) 10-2024-0086310

(51) Int. Cl. B60L 58/12; B60R 16/023

(52) U.S. Cl. CPC B60L 58/12; B60R 16/0232; B60L 2250/26

(57) ABSTRACT

A battery control apparatus and a method thereof are provided. The battery control apparatus includes an interface that transmits at least one signal to battery system assembly (BSA), a memory, and a processor. The processor transmits an interlock signal indicating a state in which the BSA is mounted on a vehicle to the BSA via the interface, in a virtual environment corresponding to a real environment in which the BSA is mounted on the vehicle, transmits at least one of a starting signal indicating that the vehicle is ignition on or a vehicle signal associated with driving of the vehicle, or any combination thereof to the BSA, and diagnoses a state of the BSA, in a state in which power relay assembly (PRA) included in the BSA is activated in response to the at least one.

### CROSS-REFERENCE TO RELATED APPLICATION

This application claims the benefit of priority to Korean Patent Application No. 10-2024-0086310, filed in the Korean Intellectual Property Office on Jul. 1, 2024, the entire contents of which are incorporated herein by reference.

### TECHNICAL FIELD

The present disclosure relates to a battery control apparatus and a method thereof, and more particularly, relates to technologies for diagnosing a state of a battery.

### BACKGROUND

With the development of scientific technology, electric vehicles have been developed and have come into wide use. Because a battery (e.g., a lithium (Li)-ion battery) is used as a major part of the electric vehicle, a technology capable of safely driving the battery is essential. Particularly, there is a need to evaluate a state of the battery released from the electric vehicle. Battery charging and discharging evaluation may be used as an evaluation method. An electrical connection between the battery and a charger/discharger may be required for the battery charging and discharging evaluation. However, because the electrical connection between the battery and the charger/discharger is impossible if a power relay assembly (PRA) in a battery system assembly (BSA) is not turned on, there can be a need to disassemble the BSA. Thus, there is a need to study a method for electrically connecting the battery in the BSA with the charger/discharger without disassembling the BSA.

### SUMMARY

The present disclosure has been made to solve the above-mentioned problems occurring in the prior art while advantages achieved by the prior art are maintained intact.

An aspect of the present disclosure provides a battery control apparatus for diagnosing battery system assembly (BSA) released from a vehicle and a method thereof.

Another aspect of the present disclosure provides a battery control apparatus for transmitting a vehicle signal indicating a data signal associated with a vehicle to released BSA to diagnose the BSA and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery control apparatus may include an interface that transmits at least one signal to battery system assembly (BSA), a memory, and a processor. The processor may transmit an interlock signal indicating a state in which the BSA is mounted on a vehicle to the BSA via the interface, in a virtual environment corresponding to a real environment in which the BSA is mounted on the vehicle, may transmit at least one of a starting signal indicating that the vehicle is ignition on or a vehicle signal associated with driving of the vehicle, or any combination thereof to the BSA, and may diagnose a state of the BSA, in a state in which power relay assembly (PRA) included in the BSA is activated in response to the at least one.

For example, the processor may transmit the interlock signal to the BSA, based on being connected with at least one pin included in the BSA via the interface.

For example, the processor may generate the vehicle signal indicating a data signal generated by a controller corresponding to the at least one pin and may diagnose the state of the BSA, based on transmitting the vehicle signal to the BSA.

For example, the processor may periodically transmit a connection signal indicating a state in which the BSA is connected with the controller to the BSA to maintain the virtual environment.

For example, the processor may receive voltage data in response to the vehicle signal from the BSA and may perform integrity verification for the voltage data.

For example, the processor may identify a state of health (SOH) of the BSA, after performing the integrity verification for the voltage data.

For example, the processor may diagnose the state of the BSA, based on performing at least one of insulation resistance evaluation, voltage evaluation, impedance evaluation, direct current internal resistance (DCIR) evaluation, or charging and discharging evaluation, or any combination thereof.

For example, the starting signal may include a brake signal indicating an input to a brake pedal of the vehicle and a battery signal for starting of the vehicle.

For example, the processor may transmit a specified voltage for applying power of the BSA to the BSA, in the virtual environment.

According to another aspect of the present disclosure, a battery control method may include transmitting an interlock signal indicating a state in which battery system assembly (BSA) is mounted on a vehicle to the BSA via an interface, in a virtual environment corresponding to a real environment in which the BSA is mounted on the vehicle, transmitting at least one of a starting signal indicating that the vehicle is ignition on or a vehicle signal associated with driving of the vehicle, or any combination thereof to the BSA, and diagnosing a state of the BSA, in a state in which power relay assembly (PRA) included in the BSA is activated in response to the at least one.

For example, the transmitting of the interlock signal may include transmitting the interlock signal to the BSA, based on being connected with at least one pin included in the BSA via the interface.

For example, the diagnosing of the state of the BSA may include generating the vehicle signal indicating a data signal generated by a controller corresponding to the at least one pin and diagnosing the state of the BSA, based on transmitting the vehicle signal to the BSA.

For example, the battery control method may further include periodically transmitting a connection signal indicating a state in which the BSA is connected with the controller to the BSA to maintain the virtual environment.

For example, the generating of the vehicle signal may include receiving voltage data in response to the vehicle signal from the BSA and performing integrity verification for the voltage data.

For example, the diagnosing of the state of the BSA may include identifying a state of health (SOH) of the BSA, after performing the integrity verification for the voltage data.

For example, the diagnosing of the state of the BSA may include diagnosing the state of the BSA, based on performing at least one of insulation resistance evaluation, voltage evaluation, impedance evaluation, direct current internal resistance (DCIR) evaluation, or charging and discharging evaluation, or any combination thereof.

For example, the starting signal may include a brake signal indicating an input to a brake pedal of the vehicle and a battery signal for starting of the vehicle.

According to another aspect of the present disclosure, a battery control system may include a battery control apparatus and battery system assembly (BSA). The battery control apparatus may transmit an interlock signal indicating a state in which the battery control apparatus is mounted on a vehicle to the BSA, in a state in which the battery control apparatus is connected with the BSA, may transmit at least one of a starting signal associated with the vehicle or a vehicle signal associated with the vehicle, or any combination thereof to the BSA, and may diagnose a state of the BSA. The BSA may identify a virtual environment corresponding to a real environment in which the BSA is mounted on the vehicle, based on receiving the interlock signal, and may drive power relay assembly (PRA) for controlling an output of a battery, based on receiving the at least one of the starting signal or the vehicle signal, or the any combination thereof, in the virtual environment.

For example, the BSA may output a voltage corresponding to the at least one of the starting signal or the vehicle signal, or the any combination thereof, based on driving the PRA.

For example, the BSA may receive voltage feedback data from the battery control apparatus in response to the voltage and may verify integrity for the voltage feedback data.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram associated with a battery control apparatus according to an embodiment of the present disclosure;

FIG. 2 illustrates an example of a block diagram associated with a battery system assembly (BSA) according to an embodiment of the present disclosure;

FIG. 3 illustrates an example of a flowchart illustrating an operation of a battery control apparatus according to an embodiment of the present disclosure;

FIG. 4 illustrates an example of a flowchart illustrating an operation of transmitting an interlock signal in a battery control apparatus according to an embodiment of the present disclosure;

FIG. 5 illustrates an example of a flowchart illustrating an operation of transmitting a starting signal in a battery control apparatus according to an embodiment of the present disclosure;

FIG. 6 illustrates an example of a flowchart illustrating an operation of transmitting a vehicle signal in a battery control apparatus according to an embodiment of the present disclosure;

FIG. 7 illustrates an example of a flowchart illustrating an operation of diagnosing a state of BSA in a battery control apparatus according to an embodiment of the present disclosure;

FIG. 8 illustrates an example of an exemplary flowchart illustrating a battery control method according to an embodiment of the present disclosure; and

FIG. 9 illustrates a computing system associated with a battery control apparatus or a battery control method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The term “module” used in various embodiments of the present disclosure may include a unit implemented with hardware, software, or firmware, and may be interchangeably used with terms, for example, “logic,” “logic block,” “part,” or “circuitry”. A module may be an integral part, or a minimum unit or portion thereof, adapted to perform one or more functions. In an embodiment, the module may be implemented in the form of an application-specific integrated circuit (ASIC). According to various embodiments, operations performed by the module, the program, or another component may be carried out sequentially, in parallel, or repeatedly, or one or more of the operations may be executed in a different order or omitted, or one or more other operations may be added.

Various embodiments of the present disclosure may be implemented as software (e.g., a program) including one or more instructions stored in a storage medium (e.g., an internal memory or an external memory) readable by a machine (e.g., a battery control apparatus 100). For example, a processor (e.g., a processor 110) of the device (e.g., the battery control apparatus 100) may invoke at least one of the stored one or more instructions from the storage medium and may execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not differentiate between where data is semipermanently stored in the storage medium and where data is temporarily stored in the storage medium.

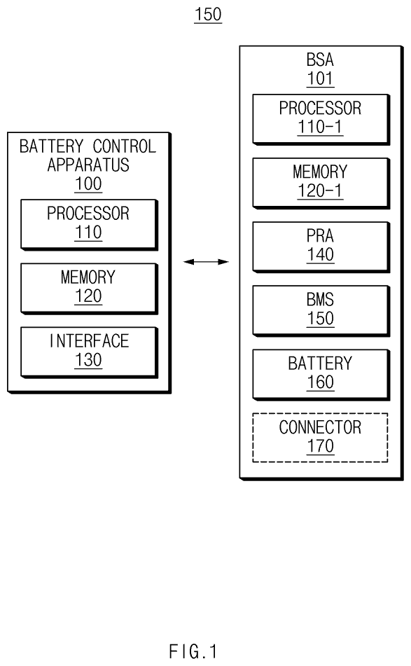

Hereinafter, embodiments of the present disclosure will be described in detail with reference to FIGS. 1 to 9.

FIG. 1 illustrates an example of a block diagram associated with a battery control apparatus according to an embodiment of the present disclosure.

Referring to FIG. 1, a battery control apparatus 100 according to an embodiment of the present disclosure may be implemented inside or outside a battery system assembly (BSA), and some of components included in the battery control apparatus 100 may be implemented inside or outside the BSA. In this case, the battery control apparatus 100 may be integrally configured with control units in the BSA or may be implemented as a separate device to be connected with the control units of the BSA by a separate connection means. For example, the battery control apparatus 100 may further include components which are not shown in FIG. 1.

A battery control system 150 according to embodiment may include a BSA 101 and a battery control apparatus 100 for diagnosing the BSA 101.

The battery control apparatus 100 according to an embodiment may include at least one of a processor 110, a memory 120, or an interface 130. The processor 110, the memory 120, and the interface 130 may be electronically or operably coupled with each other by an electronic component including a communication bus. Hereinafter, that pieces of hardware are operably coupled with each other may mean that a direct connection or an indirect connection between the pieces of hardware is established in a wired or wireless manner, such that second hardware is controlled by first hardware among the pieces of hardware. They are illustrated based on the different blocks, but an embodiment is not limited thereto. Some of the pieces of hardware of FIG. 1 (e.g., at least some of the processor 110, the memory 120, and a communication circuit (not shown)) may be included in a single integrated circuit such as a system on a chip (SoC).

The processor 110 of the battery control apparatus 100 according to an embodiment may include a hardware component for processing data based on one or more instructions. The hardware component for processing the data may include, for example, an arithmetic and logic unit (ALU), a floating point unit (FPU), a field programmable gate array (FPGA), a central processing unit (CPU), a micro controlling unit (MCU), and/or an application processor (AP). The number of the processors 110 may be one or more in number. For example, the processor 110 may have a structure of a multi-core processor including a dual core, a quad core, a hexa core, or an octa core.

The memory 120 of the battery control apparatus 100 may include a hardware component for storing data and/or instructions input and/or output from the processor 110. The memory 120 may include, for example, a volatile memory, such as a random-access memory (RAM), and/or a non-volatile memory, such as a read-only memory (ROM). For example, the volatile memory may include at least one of a dynamic RAM (DRAM), a static RAM (SRAM), a cache RAM, or a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disc, or an embedded multi-media card (eMMC). The battery control apparatus 100 may be associated with the battery control system 150 for diagnosing a state of the BSA released from a vehicle (or an external device on which a battery is mounted).

The interface 130 of the battery control apparatus 100 according to an embodiment may be configured to transmit at least one signal to the BSA 101. For example, the battery control apparatus 100 may establish a connection with the BSA 101 via the interface 130. The battery control apparatus 100 may transmit the at least one signal to the BSA 101 via the interface 130 to cause an operation of the BSA 101.

For example, the interface 130 of the battery control apparatus 100 may be configured to generate various battery measurement values from the battery. To this end, the interface 130 may include a measurement means such as a voltmeter, an ammeter, or a thermometer. For example, the battery control apparatus 100 may identify a voltage of the battery (e.g., a battery 160 of FIG. 1) via the interface 130. However, it is not limited thereto.

The BSA 101 according to embodiment may include at least one of a processor 110-1, a memory 120-1, a power relay assembly (PRA) 140, a battery management system (BMS) 150, the battery 160, or a connector 170. The processor 110-1, the memory 120-1, the PRA 140, the BMS 150, the battery 160, and the connector 170 may be electronically or operably coupled with each other by an electronic component including a communication bus. Hereinafter, that pieces of hardware are operably coupled with each other may mean that a direct connection or an indirect connection between the pieces of hardware is established in a wired or wireless manner, such that second hardware is controlled by first hardware among the pieces of hardware. They are illustrated based on the different blocks, but an embodiment is not limited thereto. Some of the pieces of hardware of FIG. 1 (e.g., at least some of the processor 110-1, the memory 120-1, and a communication circuit (not shown)) may be included in a single integrated circuit such as a system on a chip (SoC).

For example, each of the processor 110-1 and the memory 120-1 of the BSA 101 may include a hardware part and/or a circuit corresponding to each of the processor 110 and the memory 120 of the battery control apparatus 100. Hereinafter, a duplicated description will be omitted.

For example, the processor 110-1 of the BSA 101 may include a battery management unit (BMU).

The PRA 140 of the BSA 101 according to embodiment may be configured to control power output from the battery 160. For example, the battery control apparatus 100 may change the PRA 140 from an inactive state to an active state based on transmitting the at least one signal to the BSA 101 via the interface 130.

The BMS 150 of the BSA 101 according to embodiment may be configured to manage the battery 160. For example, the BMS 150 may be configured to control a temperature of the battery 160. For example, the BMS 150 may be configured to monitor a state (e.g., a temperature, a voltage, a current, and/or a state of charge) of the battery 160.

The battery control apparatus 100 according to embodiment may cause the BMS 150 to perform at least one operation, based on transmitting the at least one signal to the BSA 101.

The battery 160 of the BSA 101 according to embodiment may include at least one battery cell capable of being charged and/or discharged. Herein, the at least one battery cell may be a basic unit of the battery which may charges and discharges electric energy to use the electric energy. For example, the at least one battery cell may be, but is not limited to, a lithium-ion (Li-ion) battery, a Li-ion polymer battery, a nickel-cadmium (Ni—Cd) battery, a nickel-metal hydride (Ni-MH) battery, or the like.

The connector 170 of the BSA 101 according to embodiment may be used to establish a connection between the BSA 101 and an external device (e.g., a micro controller unit (MCU)). The connector 170 may include at least one pin for establishing a connection with the external device. The BSA 101 may establish the connection with the external device using the connector 170. The BSA 101 may receive an interlock signal from the connector 170 to identify the connection established with the external device.

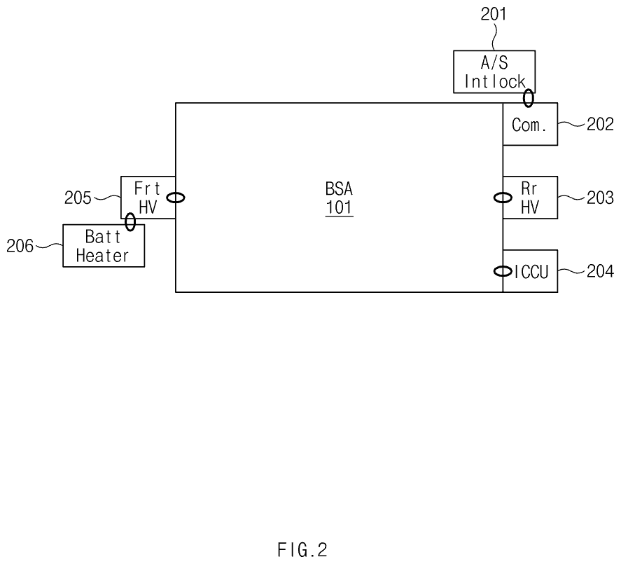

For example, the BSA 101 may identify the connection established with the external device, based on identifying a current (or a voltage) using the connector 170. For example, the BSA 101 may identify the connection established with the external device, based on that a level (e.g., a high level or a low level) of the voltage identified by means of the connector 170 is changed. An example of the connector 170 included in the BSA 101 will be described below with reference to FIG. 2.

The battery control apparatus 100 according to embodiment may establish a connection with the BSA 101. For example, the battery control apparatus 100 may establish the connection with the BSA 101 by means of the connector 170 using the interface 130. However, it is not limited thereto. For example, the battery control apparatus 100 may indirectly establish a connection with the BSA 101 using an external server.

The battery control apparatus 100 according to embodiment may transmit the interlock signal indicating a state in which it is mounted on the vehicle, in the state in which it is connected with the BSA 101. For example, the BSA 101 may identify the interlock signal received from the connector 170 to identify the connection with the battery control apparatus 100.

For example, the BSA 101 may identify a virtual environment corresponding to a real environment in which it is mounted on the vehicle, based on receiving the interlock signal. For example, the BSA 101 may infer the state in which it is mounted on the vehicle based on receiving the interlock signal from the battery control apparatus 100, in the state in which it is released from the vehicle. In the virtual environment, the vehicle may include a virtual vehicle corresponding to the vehicle which is actually present.

The battery control apparatus 100 according to embodiment may transmit at least one of a starting signal associated with the vehicle or a vehicle signal associated with the vehicle, or any combination thereof to the BSA 101.

The BSA 101 according to embodiment may drive power relay assembly (PRA) 140 for controlling an output of the battery 160, based on receiving the at least one of the starting signal or the vehicle signal, or the any combination thereof, in the virtual environment.

The BSA 101 according to embodiment may output a voltage corresponding to the at least one of the starting signal or the vehicle signal, or the any combination thereof, based on driving the PRA 140. The BSA 101 may output the voltage corresponding to the at least one via the connector 170 using the battery 160.

The battery control apparatus 100 according to embodiment may obtain voltage feedback data for the identified voltage via the connector 170. The battery control apparatus 100 may transmit the voltage feedback data to the BSA 101.

The BSA 101 according to embodiment may receive the voltage feedback data from the battery control apparatus 100 in response to the voltage. For example, the BSA 101 may verify integrity for the voltage feedback data.

The battery control apparatus 100 according to embodiment may diagnose a state of the BSA 101, in the state in which the PRA 140 of the BSA 101 is driven.

The battery control apparatus 100 according to embodiment may transmit the interlock signal indicating a state in which the BSA 101 is mounted on the vehicle to the BSA 101 via the interface 130, in the virtual environment corresponding to the real environment in which the BSA 101 is mounted on the vehicle. For example, the battery control apparatus 100 may transmit the interlock signal to the BSA 101, based on being connected with the at least one pin included in the BSA 101 via the interface 130.

The battery control apparatus 100 according to embodiment may transmit at least one of a starting signal indicating that the vehicle is ignition on or a vehicle signal associated with driving of the vehicle, or any combination thereof to the BSA 101.

The battery control apparatus 100 according to embodiment may diagnose a state of the BSA 101, in the state in which the PRA 140 included in the BSA 101 is activated, in response to the at least one.

In an embodiment, the starting signal may include a brake signal indicating an input to the brake pedal of the vehicle and a battery signal for starting of the vehicle. For example, the battery control apparatus 100 may transmit a specified voltage for applying power of the BSA 101 to the BSA 101, in the virtual environment. The BSA 101 may change from an inactive state (or an idle state) to an active state, based on receiving the specified voltage. For example, the battery signal may have a voltage (e.g., 12 V) for initiating an operation of the vehicle. The BSA 101 may receive the starting signal in the virtual environment to identify that the vehicle is turned on (or ignition on).

The battery control apparatus 100 according to embodiment may transmit the vehicle signal associated with the driving of the vehicle to the BSA 101 via the connector 170, depending on a specified protocol. For example, the battery control apparatus 100 may transmit a vehicle signal indicating a failure state, a communication state, and/or a feedback state for a controller (e.g., an MCU) corresponding to the connector 170. For example, the BSA 101 may receive the vehicle signal to identify that the driving of the vehicle is initiated. The BSA 101 may output a voltage corresponding to the driving of the vehicle.

The battery control apparatus 100 according to embodiment may generate a vehicle signal indicating a data signal generated by the controller corresponding to the at least one pin of the connector 170. For example, the battery control apparatus 100 may diagnose a state of the BSA 101, based on transmitting the vehicle signal to the BSA 101.

The battery control apparatus 100 according to embodiment may periodically transmit a connection signal indicating a state in which it is connected with the controller to the BSA 101 to maintain the virtual environment. For example, the operation of transmitting the connection signal may include an operation of changing data included in the at least one signal transmitted and received between the battery control apparatus 100 and the BSA 101. For example, the battery control apparatus 100 may periodically change the data included in the at least one signal to maintain the connection established with the BSA 101. For example, the connection signal may be referred to as a “heartbeat count”. For example, the battery control apparatus 100 may change a value for the heartbeat count to motor a communication state of the connection established with the BSA 101.

The battery control apparatus 100 according to embodiment may receive voltage data in response to the vehicle signal from the BSA 101. The battery control apparatus 100 may perform integrity verification for the voltage data. For example, the battery control apparatus 100 may generate cyclic redundancy check (CRC) data for the voltage data to perform the integrity verification for the voltage data. The voltage data may indicate a voltage for initiating driving of the controller.

After performing the integrity verification for the voltage data, the battery control apparatus 100 according to embodiment may diagnose a state of the BSA 101. For example, the battery control apparatus 100 may identify a state of health (SOH) of the BSA 101.

The battery control apparatus 100 according to embodiment may diagnosis the state of the BSA 101, based on performing at least one of insulation resistance evaluation, voltage evaluation, impedance evaluation, direct current internal resistance (DCIR) evaluation, charging and discharging evaluation, or any combination thereof. For example, while the PRA 140 of the BSA 101 is being driven, the battery control apparatus 100 may diagnose the state of the BSA 101. For example, the battery control device 100 may provide the diagnosed result of diagnosing the state of the BSA 101. For example, the battery control apparatus 100 may transmit the diagnosed result to the external server to provide the diagnosed result. For example, the battery control device 100 may display the diagnosed result on a display (not shown). However, it is not limited thereto.

As described above, the battery control apparatus 100 according to embodiment may diagnose the state of the BSA 101 released from the vehicle (or the external device using the battery). The battery control apparatus 100 may initiate driving of the BSA 101 to diagnose the state of the BSA 101. The battery control apparatus 100 may transmit at least one signal associated with the vehicle (or at least one signal indicating data generated by the vehicle) to recognize the state in which the BSA 101 is mounted on the vehicle, in the state in which it is connected with the BSA 101, to initiate the driving of the BSA 101. While transmitting the at least one signal, the battery control apparatus 100 may diagnose the state of the BSA 101. The battery control apparatus 100 provide a service capable of diagnosing the state of the BSA 101 without disassembling the BSA 101.

FIG. 2 illustrates an example of a block diagram associated with BSA according to an embodiment of the present disclosure. BSA 101 of FIG. 2 may be referred to BSA 101 of FIG. 1.

The BSA 101 according to embodiment may include a connector (e.g., a connector 170 of FIG. 1) for a connection with an external device. The number of connectors included in the BSA 101 may be one or more. For example, the connector included in the BSA 101 may include at least one pin for a connection with the external device.

In an embodiment, the BSA 101 may include an after service (A/S) interlock connector 201, a communication connector 202, a front high voltage connector 205, a rear high voltage connector 203, an integrated charging control unit (ICCU) connector 204, and/or a battery heater 206.

For example, the BSA 101 may establish a communication link with the external device, using the A/S interlock connector 201 (or the communication connector 202).

For example, the BSA 101 may establish a connection with a controller (e.g., an MCU) associated with a vehicle, using the front high voltage connector 205 or the rear high voltage connector 203. For example, the number of controllers may be two or more.

For example, the BSA 101 may include a diagnosis circuit for diagnosing a battery, a sensor for sensing a state of the battery, and an inverter for outputting a voltage.

For example, the BSA 101 may receive at least one signal corresponding to a controller associated with at least one of the one or more connectors 201, 202, 203, 204, 205, and 206 from a battery control apparatus (e.g., a battery control apparatus 100 of FIG. 1). For example, the BSA 101 may verify integrity for the at least one signal. After the integrity for the at least one signal is verified, the BSA 101 may output a voltage corresponding to the at least one signal via at least one of the one or more connectors 201, 202, 203, 204, 205, and 206.

For example, the battery control apparatus may generate voltage feedback data for the voltage, based on identifying the voltage. The battery control apparatus may transmit the voltage feedback data to the BSA 101 to share whether there is an error in output of the voltage with the BSA 101.

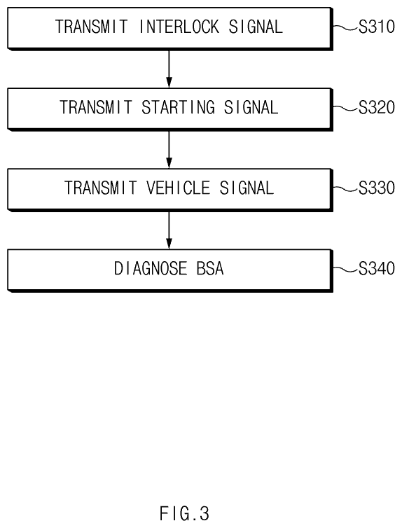

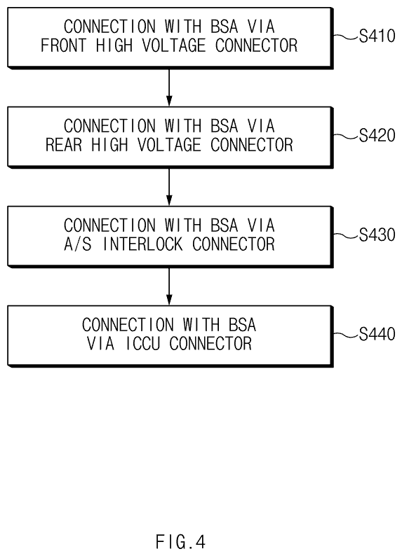

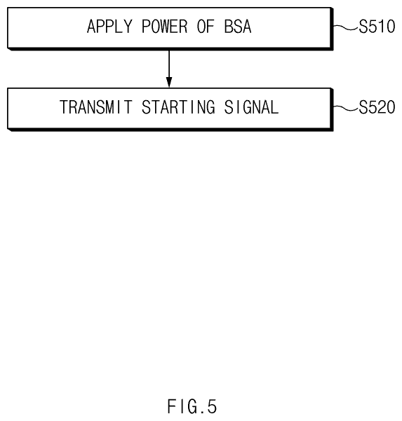

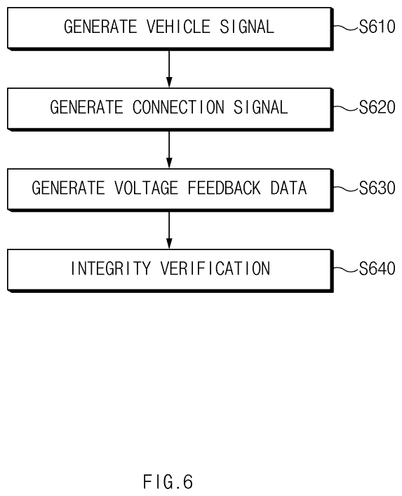

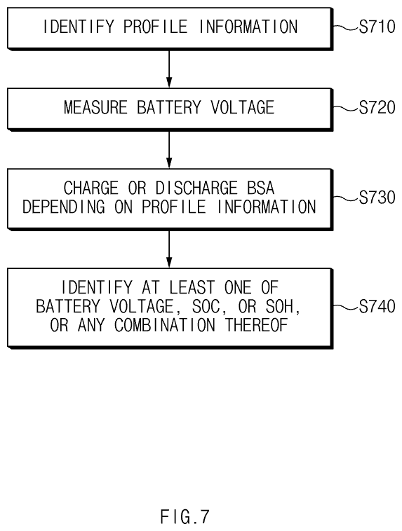

FIG. 3 illustrates an example of a flowchart illustrating an operation of a battery control apparatus according to an embodiment of the present disclosure. FIG. 4 illustrates an example of a flowchart illustrating an operation of transmitting an interlock signal in a battery control apparatus according to an embodiment of the present disclosure. FIG. 5 illustrates an example of a flowchart illustrating an operation of transmitting a starting signal in a battery control apparatus according to an embodiment of the present disclosure. FIG. 6 illustrates an example of a flowchart illustrating an operation of transmitting a vehicle signal in a battery control apparatus according to an embodiment of the present disclosure. FIG. 7 illustrates an example of a flowchart illustrating an operation of diagnosing a state of a BSA in a battery control apparatus according to an embodiment of the present disclosure.

Hereinafter, it is assumed that a battery control apparatus 100 of FIG. 1 performs processes of FIGS. 3 to 7. Furthermore, in descriptions of FIGS. 3 and 7, an operation described as being performed by a battery control apparatus may be understood as being controlled by a processor 110 of the battery control apparatus 100. The respective operations of FIGS. 3 to 7 may be sequentially performed, but are not necessarily sequentially performed. For example, an order of the respective operations may be changed, and at least two operations may be performed in parallel.

Referring to FIG. 3, in S310, the battery control apparatus according to an embodiment may transmit an interlock signal. For example, the battery control apparatus may establish a connection with BSA (e.g., the BSA 101 of FIG. 1) via an interface (e.g., the interface 130 of FIG. 1). For example, as the BSA and the battery control apparatus establish the connection, an interlock signal changes to a low level. For example, the battery control apparatus may provide the BSA with a virtual environment corresponding to a real environment in which it is mounted on a vehicle, based on transmitting the interlock signal. S310 of FIG. 3 may be associated with at least one of the operations of FIG. 4.

Referring to FIG. 4, in S410, the battery control apparatus according to embodiment may establish a connection with the BSA via a front high voltage connector (e.g., a front high voltage connector 205 of FIG. 2). For example, the BSA may identify a short circuit of a circuit included in the front high voltage connector to identify a connection of the battery control apparatus.

Referring to FIG. 4, in S420, the battery control apparatus according to embodiment may establish a connection with the BSA via a rear high voltage connector (e.g., a rear high voltage connector 203 of FIG. 2). For example, the BSA may identify a short circuit of a circuit included in the rear high voltage connector to identify a connection of the battery control apparatus.

Referring to FIG. 4, in S430, the battery control apparatus according to embodiment may establish a connection with the BSA via an A/S interlock connector (e.g., an A/S interlock connector 201 of FIG. 2). For example, the BSA may identify a short circuit of a circuit included in the A/S interlock connector to identify a connection of the battery control apparatus.

Referring to FIG. 4, in S440, the battery control apparatus according to embodiment may establish a connection with the BSA via an ICCU connector (e.g., an ICCU connector 204 of FIG. 2). For example, the BSA may identify a short circuit of a circuit included in the ICCU connector to identify a connection of the battery control apparatus.

In an embodiment, the BSA may receive an interlock signal via the connector, in a virtual environment, to identify a state in which it is connected with a controller corresponding to the connector.

Referring again to FIG. 3, in S320, the battery control apparatus according to an embodiment may transmit a starting signal to the BSA. S320 of FIG. 3 may be associated with at least one of the operations of FIG. 5.

Referring to FIG. 5, in S510, the battery control apparatus according to embodiment may apply a voltage for powering on the BSA, via the connection established with the BSA. The BSA may initiate driving of the BSA, based on that the voltage is applied.

For example, the battery control apparatus may transmit a specified voltage for applying power of the BSA to the BSA. For example, the battery control apparatus may apply the voltage to initiate driving of a processor (e.g., a BMU) included in the BSA.

Referring to FIG. 5, in S520, the battery control apparatus according to an embodiment may transmit the starting signal to the BSA.

For example, the battery control apparatus may transmit the starting signal indicating that the vehicle is ignition on to the BSA. For example, the starting signal may include a brake signal indicating an input to the brake pedal of the vehicle and a battery signal for starting of the vehicle. For example, the starting signal indicating that the vehicle is ignition on may have a specified voltage (e.g., 12 V).

Referring again to FIG. 3, in S330, the battery control apparatus according to an embodiment may transmit a vehicle signal.

For example, the battery control apparatus may transmit the vehicle signal indicating (or simulating) a data signal generated by a controller (e.g., a high voltage component controller (HVCC)) corresponding to the connector to the BSA. For example, the battery control apparatus may generate the vehicle signal indicating the data signal, depending on a predefined protocol indicating information transmitted and received between the controller corresponding to the connector and the BSA. S330 of FIG. 3 may be associated with at least one of the operations of FIG. 6.

For example, the BSA may verify the vehicle signal. For example, if the vehicle signal is the same as a data signal received from a real controller, the BSA may drive PRA.

Referring to FIG. 6, in S610, the battery control apparatus according to embodiment may generate the vehicle signal.

For example, before transmitting the vehicle signal to the BSA, the battery control apparatus may check whether a processor (e.g., a BMU) included in the BSA is in a relayed state. For example, if the processor included in the BSA is not relayed, the battery control apparatus may temporarily suspend performing the operations of FIG. 6. For example, if the processor included in the BSA is relayed, the battery control apparatus may perform S610.

Referring to FIG. 6, in S620, the battery control apparatus according to embodiment may generate a connection signal. For example, the battery control apparatus may identify data (or a bit) included in at least one signal for being transmitted to the BSA to check a connection state with the BSA. For example, if transmitting the at least one signal, the battery control apparatus may change a heartbeat count to maintain the connection with the BSA.

Referring to FIG. 6, in S630, the battery control apparatus according to embodiment may generate voltage feedback data. For example, the battery control apparatus may receive voltage data corresponding to the vehicle signal from the BSA. For example, the battery control apparatus may generate voltage feedback data for the voltage data.

In an embodiment, if the voltage data received from the BSA indicates a voltage with a first value, the battery control apparatus may generate voltage feedback data indicating the voltage with the first value.

In an embodiment, a type of the voltage data may vary with the controller corresponding to the connector which outputs the voltage data. For example, the voltage data may indicate a voltage for driving the controller corresponding to the connector. For example, the voltage data may indicate ignition-on data for initiating starting of the vehicle. For example, the voltage data may vary with a predefined protocol.

Referring to FIG. 6, in S640, the battery control apparatus according to embodiment may perform integrity verification for the voltage feedback data.

In an embodiment, the battery control apparatus may transmit the voltage feedback data to the BSA to check whether the voltage data output from the BSA is an accurate value. For example, the battery control apparatus may generate a CRC for the voltage feedback data to perform integrity verification for the voltage feedback data.

Referring again to FIG. 3, in S340, the battery control apparatus according to an embodiment may diagnose a state of the BSA. For example, while the PRA of the BSA is being driven, the battery control apparatus may diagnose the state of the BSA (or the battery).

In an embodiment, the battery control apparatus may charge (and discharge) the BSA using a determined charging rate (e.g., a C-rate) after a high voltage path is ensured via the connector.

For example, while charging (and discharging) the BSA, the battery control apparatus may measure a voltage and an accumulated current.

For example, the battery control apparatus may check a charging (and discharging) current capacity Ah.

For example, the battery control apparatus may compare current capacities based on the beginning of life (BOL) to identify a state of health (SOH).

S340 of FIG. 3 may be associated with at least one of the operations of FIG. 7.

Referring to FIG. 7, in S710, the battery control apparatus according to embodiment may identify profile information.

For example, the profile information may indicate a profile (e.g., a charging time and a charging rate) associated with predefined charging and discharging to diagnose the battery.

Referring to FIG. 7, in S720, the battery control apparatus according to embodiment may measure a battery voltage. For example, before initiating charging of the battery, the battery control apparatus may identify a voltage of the BSA.

Referring to FIG. 7, in S730, the battery control apparatus according to an embodiment may charge or discharge the BSA depending on the profile information.

Referring to FIG. 7, in S740, the battery control apparatus according to an embodiment may identify at least one of a battery voltage, a state of charge (SOC), or an SOH, or any combination thereof.

For example, while charging (and discharging) the BSA, the battery control apparatus may measure a current.

For example, the battery control apparatus may end the charging for the BSA depending on the profile information. For example, after ending the charging, the battery control apparatus may identify a current capacity, a battery voltage, and/or an SOC. For example, the battery control apparatus may identify an SOH using a current capacity identified at a time point of BOL and a current capacity identified after ending the charging.

For example, the battery control apparatus may diagnose a state of the BSA using the SOH. For example, the battery control apparatus may provide the diagnosed result (e.g., the SOH) of diagnosing the state of the BSA.

In an embodiment, S710 to S740 may indicate a process of charging and discharging evaluation for diagnosing the state of the BSA. For example, the operation for diagnosing the state of the BSA in the battery control apparatus may further include insulation resistance evaluation, voltage evaluation, impedance evaluation, and/or direct current internal resistance (DCIR) evaluation.

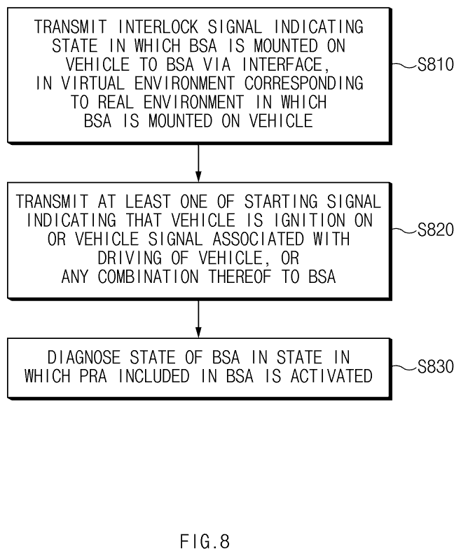

FIG. 8 illustrates an example of an exemplary flowchart illustrating a battery control method according to an embodiment of the present disclosure. Hereinafter, it is assumed that a battery control apparatus 100 of FIG. 1 performs a process of FIG. 8. Furthermore, in a description of FIG. 8, an operation described as being performed by an apparatus may be understood as being controlled by a processor 110 of the battery control apparatus 100. The respective operations of FIG. 8 may be sequentially performed, but are not necessarily sequentially performed. For example, an order of the respective operations may be changed, and at least two operations may be performed in parallel.

Referring to FIG. 8, in S810, the battery control method according to embodiment may include transmitting an interlock signal indicating a state in which BSA is mounted on a vehicle to the BSA via an interface, in a virtual environment corresponding to a real environment in which the BSA is mounted on the vehicle.

For example, the battery control method may include transmitting the interlock signal to the BSA as a battery control apparatus and a connector of the BSA are connected with each other. For example, transmitting the interlock signal may be associated with S310 of FIG. 3.

Referring to in S820, the battery control method according to embodiment may include transmitting at least one of a starting signal indicating that the vehicle is ignition on or a vehicle signal associated with driving of the vehicle, or any combination thereof to the BSA.

For example, transmitting the starting signal indicating that the vehicle is ignition on may be associated with S320 of FIG. 3.

For example, transmitting the vehicle signal associated with the driving of the vehicle may be associated with S330 of FIG. 3.

Referring to FIG. 8, in S830, the battery control method according to an embodiment may include diagnosing a state of the BSA, in a state in which PRA included in the BSA is activated. For example, the state in which the PRA is activated may include a state in which the PRA is short-circuited. For example, diagnosing the state of the BSA may be associated with S340 of FIG. 3.

As described above, the battery control apparatus for performing the battery control method may evaluate the BSA without the necessity of disassembling the released BSA. The battery control apparatus may provide a service for evaluating the BSA without the necessity of disassembling the BSA, thus reducing the evaluation cost of the BSA.

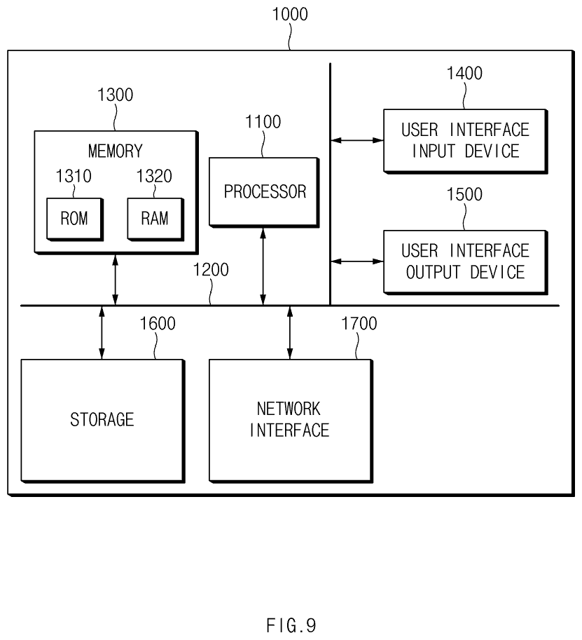

FIG. 9 illustrates a computing system associated with a battery control apparatus or a battery control method according to an embodiment of the present disclosure.

Referring to FIG. 9, the computing system 1000 may include at least one processor 1100, a memory 1300, a user interface input device 1400, a user interface output device 1500, storage 1600, and a network interface 1700 connected through a system bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The present technology may diagnose BSA released from a vehicle.

Furthermore, the present technology may transmit a vehicle signal indicating a data signal associated with the vehicle to the released BSA, thus diagnosing the BSA.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed to be based on the accompanying claims, and all the technical ideas within the scope equivalent to the claims should be included in the scope of the present disclosure.

What is claimed is:

1. A battery control apparatus, comprising:
an interface configured to transmit at least one signal to a battery system assembly (BSA);
a memory; and
a processor,
wherein the processor is configured to transmit an interlock signal indicating a state in which the BSA is mounted on a vehicle to the BSA via the interface, in a virtual environment corresponding to a real environment in which the BSA is mounted on the vehicle,
transmit at least one of a starting signal indicating that the vehicle is ignition on or a vehicle signal associated with driving of the vehicle, or any combination thereof to the BSA, and
diagnose a state of the BSA, in a state in which power relay assembly (PRA) included in the BSA is activated in response to the at least one.

2. The battery control apparatus of claim 1, wherein the processor is configured to
transmit the interlock signal to the BSA, based on being connected with at least one pin included in the BSA via the interface.

3. The battery control apparatus of claim 2, wherein the processor is configured to
generate the vehicle signal indicating a data signal generated by a controller corresponding to the at least one pin, and
diagnose the state of the BSA, based on transmitting the vehicle signal to the BSA.

4. The battery control apparatus of claim 3, wherein the processor is configured to
periodically transmit a connection signal indicating a state in which the BSA is connected with the controller to the BSA to maintain the virtual environment.

5. The battery control apparatus of claim 3, wherein the processor is configured to
receive voltage data in response to the vehicle signal from the BSA, and
perform integrity verification for the voltage data.

6. The battery control apparatus of claim 5, wherein the processor is configured to
identify a state of health (SOH) of the BSA, after performing the integrity verification for the voltage data.

7. The battery control apparatus of claim 1, wherein the processor is configured to
diagnose the state of the BSA, based on performing at least one of insulation resistance evaluation, voltage evaluation, impedance evaluation, direct current internal resistance (DCIR) evaluation, or charging and discharging evaluation, or any combination thereof.

8. The battery control apparatus of claim 1, wherein the starting signal includes a brake signal indicating an input to a brake pedal of the vehicle and a battery signal for starting of the vehicle.

9. The battery control apparatus of claim 1, wherein the processor is configured to
transmit a specified voltage for applying power of the BSA to the BSA, in the virtual environment.

10. A battery control method, comprising:
transmitting an interlock signal indicating a state in which a battery system assembly (BSA) is mounted on a vehicle to the BSA via an interface, in a virtual environment corresponding to a real environment in which the BSA is mounted on the vehicle;
transmitting at least one of a starting signal indicating that the vehicle is ignition on or a vehicle signal associated with driving of the vehicle, or any combination thereof to the BSA; and
diagnosing a state of the BSA, in a state in which power relay assembly (PRA) included in the BSA is activated in response to the at least one.

11. The battery control method of claim 10, wherein the transmitting of the interlock signal includes
transmitting the interlock signal to the BSA, based on being connected with at least one pin included in the BSA via the interface.

12. The battery control method of claim 11, wherein the diagnosing of the state of the BSA includes
generating the vehicle signal indicating a data signal generated by a controller corresponding to the at least one pin, and
diagnosing the state of the BSA, based on transmitting the vehicle signal to the BSA.

13. The battery control method of claim 12, further comprising
periodically transmitting a connection signal indicating a state in which the BSA is connected with the controller to the BSA to maintain the virtual environment.

14. The battery control method of claim 12, wherein the generating of the vehicle signal includes
receiving voltage data in response to the vehicle signal from the BSA, and
performing integrity verification for the voltage data.

15. The battery control method of claim 14, wherein the diagnosing of the state of the BSA includes
identifying a state of health (SOH) of the BSA, after performing the integrity verification for the voltage data.

16. The battery control method of claim 10, wherein the diagnosing of the state of the BSA includes
diagnosing the state of the BSA, based on performing at least one of insulation resistance evaluation, voltage evaluation, impedance evaluation, direct current internal resistance (DCIR) evaluation, or charging and discharging evaluation, or any combination thereof.

17. The battery control method of claim 10, wherein the starting signal includes a brake signal indicating an input to a brake pedal of the vehicle and a battery signal for starting of the vehicle.

18. A battery control system, comprising:
a battery control apparatus; and
a battery system assembly (BSA),
wherein the battery control apparatus is configured to
transmit an interlock signal indicating a state in which the battery control apparatus is mounted on a vehicle to the BSA, in a state in which the battery control apparatus is connected with the BSA,
transmit at least one of a starting signal associated with the vehicle or a vehicle signal associated with the vehicle, or any combination thereof to the BSA, and
diagnose a state of the BSA, and
wherein the BSA is configured to
identify a virtual environment corresponding to a real environment in which the BSA is mounted on the vehicle, based on receiving the interlock signal, and
drive power relay assembly (PRA) for controlling an output of a battery, based on receiving the at least one of the starting signal or the vehicle signal, or the any combination thereof, in the virtual environment.

19. The battery control system of claim 18, wherein the BSA is configured to
output a voltage corresponding to the at least one of the starting signal or the vehicle signal, or the any combination thereof, based on driving the PRA.

20. The battery control system of claim 19, wherein the BSA is configured to
receive voltage feedback data from the battery control apparatus in response to the voltage, and
verify integrity for the voltage feedback data.
